(19) United States
(12) Patent Application Publication
(10) Pub. No.: US 2003/0136431 A1
(43) Pub. Date: Jul. 24, 2003

(54) Method and apparatus for cleaning of microelectronic workpieces after chemical-mechanical planarization

(75) Inventors: Dana Scranton, Kalispell, MT (US); Steve Eudy, Kalispell, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/056,706

(22) Filed: Jan. 24, 2002

(51) Int. Cl. B08B 1/04; B08B 3/00

(52) U.S. Cl. 134/63; 15/77; 134/66; 134/133; 134/157

(57) ABSTRACT

In a post chemical-mechanical polishing (CMP) procedure for cleaning a workpiece, a cleaning solution is delivered to the core of a brush where the solution is absorbed by the brush and then applied by the brush onto the workpiece. The cleaning solution is uniformly applied to the workpiece. The volumes of solutions used in the scrubbing process is reduced. A thin oxide layer is etched. A hydrophilic surface state is maintained. The workpiece is then rinsed and dried in a centrifugal processing between upper and lower rotors. A high level clean is achieved while consumption of rinsing and drying fluids is reduced.

### BACKGROUND OF THE INVENTION

### FIELD OF THE INVENTION

The field of the invention is systems and methods for processing a workpiece, such as a workpiece, a semiconductor wafer, and other flat media requiring low levels of contamination during the manufacturing process. The invention further relates to chemical-mechanical scrubbing, rinsing and drying a workpiece.

In manufacturing semiconductor devices, flat panel displays, optical masks, and similar articles or devices, the surface of the article must be cleaned of contaminants. If not removed, contaminants may affect device performance characteristics and may cause device failure to occur at faster rates than usual.

Cleaning silicon wafers in particular presents particular challenges. Silicon wafers often have a very thin oxide surface layer, such as a native or passivation oxide or a chemically grown oxide. Surface metal particles, which are contaminants which must be removed. These particles may be on top of the oxide, in the oxide or at the oxide/silicon interface. The oxide surface layer is typically less than 20 Angstroms (A) thick. Accordingly, a highly controlled etch must be used to remove contaminants from this layer. If the oxide is entirely removed, the surface becomes hydrophobic, and may become difficult to clean. Therefore, ideally, as much oxide as possible is etched away to remove contamination on the surface of the oxide layer, but without removing all of the oxide layer, to avoid having surface become hydrophobic.

One well known cleaning technique uses a scrubber that scrubs a wafer or workpiece on one or both sides. The cleaning solution used in the scrubber depends on the contaminants to be removed, the type of wafer to be scrubbed, and/or the particular application. Where a high level clean is needed, a chemical solution may be used for scrubbing. Where a lower level clean, i.e., higher contamination levels, are acceptable, so that less contamination need be removed, water may be used for scrubbing.

Two-sided scrubbers that use soft sponge like brushes to simultaneously clean both sides of the wafer or workpiece are widely and effectively used for cleaning silicon wafers via post chemical-mechanical planarization (CMP). Ammonium hydroxide solution is typically added to de-ionized water (DI water) during scrubbing to improve the cleaning performance especially in CMP cleaning. The ammonium hydroxide solution helps to remove slurry particles (and the metallic contamination associated with them) from the wafer surface. It also prevents brush loading by inducing a negative zeta potential on the particle, brush and the wafer surface.

If contamination is under the workpiece surface, within the oxide layer, an etching solution may be needed to remove the contaminants, along with a thin oxide layer from the surface. Regardless of the solution used, the workpiece must be rinsed and dried, after the CMP or other cleaning steps, to remove the cleaning solution from the workpiece. Various rinser/dryer apparatus and methods have been used for this purpose. For example, well known spin rinser/dryers have been used in cleaning apparatus, including CMP apparatus, to rinse and dry workpieces. These spin rinser/dryers may operate on one workpiece at a time, or on a batch of workpieces. Typically, such spin rinser dryers have a rotor for holding the workpieces in a near vertical orientation. The rotor spins within a chamber. Nozzles within the chamber generally spray a rinsing fluid, such as DI water onto the spinning workpieces, to rinse away cleaning solutions, or other particles or droplets on the workpiece surfaces. The workpiece is then dried by spinning at high speed, to centrifugally remove the rinsing fluid. Drying gases may also be used.

While this type of post CMP rinsing and drying has met with varying degrees of success, there remains a need for improved rinsing and drying methods and apparatus, for use after post CMP processes.

### SUMMARY OF THE INVENTION

In a method and system for cleaning workpieces, such as semiconductor wafer, a cleaning solution is provided to a core of a brush in a workpiece scrubber, to provide chemical mechanical scrubbing with in-situ etching of the workpiece with the brush. The thickness of an oxide etched is controlled as required by different applications. A thin native oxide on silicon may be etched, to remove surface contaminants without removing the entire film. This maintains a hydrophilic surface necessary for maintaining low levels of surface particles, especially in brush scrubbing systems, where the brush is in contact with the wafer surface during cleaning.

Following this cleaning procedure, the workpiece or wafer is moved into a rinser/dryer. The rinser/dryer has upper and lower rotors or chamber members which are brought together or engaged to form a rinsing/drying chamber closely conforming to the shape of the workpiece. As the rinsing/drying chamber volume is small, the workpiece can be rinsed and dried in a highly controlled way. In addition, consumption of rinsing and drying liquids and/or gases is reduced.

The invention resides as well in subcombinations of the systems and methods described. It is accordingly an object of the invention to provide improved rinsing and drying of workpieces, such as semiconductor wafers.

### BRIEF DESCRIPTION OF THE DRAWINGS

In the drawings, where the same number indicates the same element in each of the views:

FIG. 1 is a schematically illustrated side view of an apparatus according to the invention.

FIG. 2 is a side view of the rinser/dryer shown in FIG. 1.

FIG. 3 is a schematic view of liquid and gas supply lines to the rinser/dryer shown in FIGS. 1 and 2.

FIG. 4 is cut away perspective view of the rinser/dryer shown in FIGS. 1 and 2.

FIG. 5 is a section view taken along line 5-5 of FIG. 4.

FIG. 6 is an enlarged view of components shown in FIG. 5.

FIG. 7 is a bottom perspective view of the lower rotor shown in FIGS. 5 and 6.

FIG. 8 is an enlarged view of components shown in FIG. 5 adjacent to the perimeter or edge of the workpiece.

FIG. 9 is an enlarged view of alternative embodiment components shown in FIG. 5 adjacent to the perimeter or edge of the workpiece.

FIG. 10 is a top perspective view of the lower rotor shown in FIGS. 5 and 6.

FIG. 11 is an enlarged side view of the lever or arm shown in FIG. 10, with the arm in the up position.

FIG. 12 is an enlarged side view of the lever or arm shown in FIGS. 10 and 1, with the arm in the down position.

### DETAILED DESCRIPTION

The system and methods described are useful for cleaning workpieces, such as silicon wafers where a controlled thin oxide etch is used to maintain a hydrophilic surface. A controlled removal of thin layers of oxide may be performed, regardless of whether the workpiece has been polished by CMP. A cleaning solution, such as dilute is preferably applied through the PVA brushes to the surface of the workpiece during the scrubbing cycle.

To clean a workpiece having an ultrathin chemical oxide layer (typically less than 20 angstroms), very dilute HF (on the order of 0.005% HF) is used to perform an in-situ oxide etch with a controlled removal of less than approximately 15 angstroms. This removes contaminants, including particles and plated residues, on the surface of the oxide layer or within the oxide layer, without making the surface hydrophobic. A thin layer of oxide remains on the surface of the workpiece so that the surface remains hydrophilic.

To clean thicker oxide layers, e.g., greater than approximately 30 angstroms, a controlled thin oxide etch may be used. For these applications, removal of metallic particle contamination (which may be incorporated into the oxide from the CMP polishing process) is important. The metallic particle contamination may diffuse into the miroelectronic devices on the workpiece and cause them to fail. Very dilute concentrations of HF (such as 0.005% HF) may be sufficient to remove metallic contamination, depending upon the depth of penetration of the contamination into the oxide layer. If the metallic contamination is more than 20 angstroms below the surface, a higher concentration of HF may be needed. The amount of oxide removed is determined by the concentration of HF delivered to the brush, the dispense flow rate, and time.

For removing less than 15 angstroms of a native oxide layer, a 0.005% concentration of HF has a slow etch rate, with etch times of 20-60 seconds acceptable. The etch time is more critical when using higher concentrations. The concentration of HF can be adjusted to provide an oxide layer removal rate which is consistent with a desired workpiece throughput or production rate.

For back-end CMP processes, removal of up to 100 angstroms of oxide may be required to adequately remove the metallic contamination incorporated therein by the polishing process. To remove this amount of oxide in less than approximately 40 or 50 seconds, the concentration of HF is increased to 0.5-1.0%.

The CMP process is preferably performed in a scrubber that scrubs both sides of a workpiece simultaneously. The combination of mechanical double sided scrubbing with in-situ thin oxide etching allows multiple process steps to be accomplished within a single machine. This reduces handling requirements and the risks of contamination associated with handling and transport of workpieces between process machines.

The cleaning processes includes the step of delivering a hydrofluoric acid (HF) solution to a core of a brush, such as a PVA brush, in a semiconductor workpiece scrubber. After delivering the hydrofluoric acid (HF) solution to the brush core, the HF solution is applied to the workpiece through the brush, followed by chemical mechanical scrubbing of the workpiece with the brush. The solution may be applied concurrently with the brush scrubbing of the workpiece.

The concentration of the HF solution is in the range of approximately 0.005%-1.0% HF, depending upon application. The solution preferably includes a mixture of approximately 0.005 percent HF in water. The HF solution is applied for a predetermined amount of time, for example, 20-40, or 25-35 or about 35 seconds.

The term wafer or workpiece here includes a bare or pure semiconductor workpiece, with or without doping, a semiconductor workpiece with epitaxial layers, a semiconductor workpiece incorporating one or more device layers at any stage of processing, other types of workpieces incorporating one or more semiconductor layers such as workpieces having semiconductor on insulator devices, or workpieces for processing other devices such as flat panel displays, multichip modules, optical masks, memory media, etc.

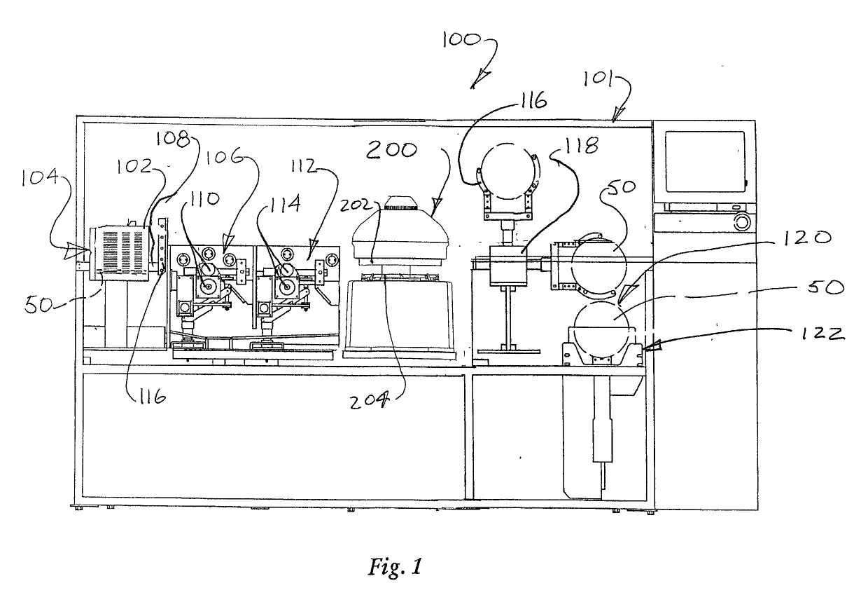

FIG. 1 is a section view of a cleaning system 100 including several stations or sections within a housing or enclosure 101. Each station performs one or more steps in the cleaning process In use, contaminated workpieces 50 are delivered into the cleaning system 100 typically after CMP or other processes resulting in contamination. The contaminated workpieces 50 within a cassette, box or tray 102 are moved into a loading station 104 of the system 100 via a door or window. Workpieces 50 are removed from the cassette 102 and placed, one at a time, into the first or outside brush station 106, by a first transfer robot 108. In the outside brush station 106, a workpiece 50 is processed through a first scrub. The workpiece is treated with chemical solution, such as ammonium hydroxide, applied to the workpiece through brushes 110 during the first scrub.

The scrubbed workpiece 50 is then transferred from the outside brush station 106 to an inside brush station 112 via the first transfer robot. In the inside brush station 112, the workpiece 50 is processed through a second scrub. In the second scrub, the workpiece is preferably treated with a second solution, such as a very dilute HF solution. As in the first scrub step, the HF solution is applied to the workpiece through brushes 114. HF may optionally be used in both scrub stations. Other solutions, such as water, citric acid, ammonium hydroxide, and ammonium citrate (or mixtures of them) may be used in either of the brush stations.

After the second scrub the workpiece is transferred from the inside brush station 112 into a rinser/dryer 200, via the first transfer robot 108. The rinser/dryer 200 rinses, spins, and dries the now clean workpiece. Once the rinse, spin, and dry steps have been completed, the workpiece is then removed from the rinser/dryer 200 and placed into a clean cassette 120 at an output or unload station 122, via a second transfer robot 118. The transfer robots 108 and 118 each preferably have a robotic arm including an end effector or hand 116 which lifts the workpiece by its edges. The clean cassette 120 is then transferred to storage or to another cleaning or processing system, either by hand, or via a facility robot external to the system 100.

The brushes 110 and/or 114 may be PVA sponge brushes. During etching, the chemical solution is distributed to the rotating brushes so that the brushes are evenly soaked with the solution. The brushes are preferably saturated with the solution by absorbing the solution through the slots or holes in the brush core. The chemical solution is applied to the workpiece via the rotating bushes until the desired amount of the oxide layer is removed. Once the desired level is reached, the etch is stopped. To stop the etch, the chemical solution to the brushes is turned off. A water supply line is turned on to rinse the workpiece and stop the etching.

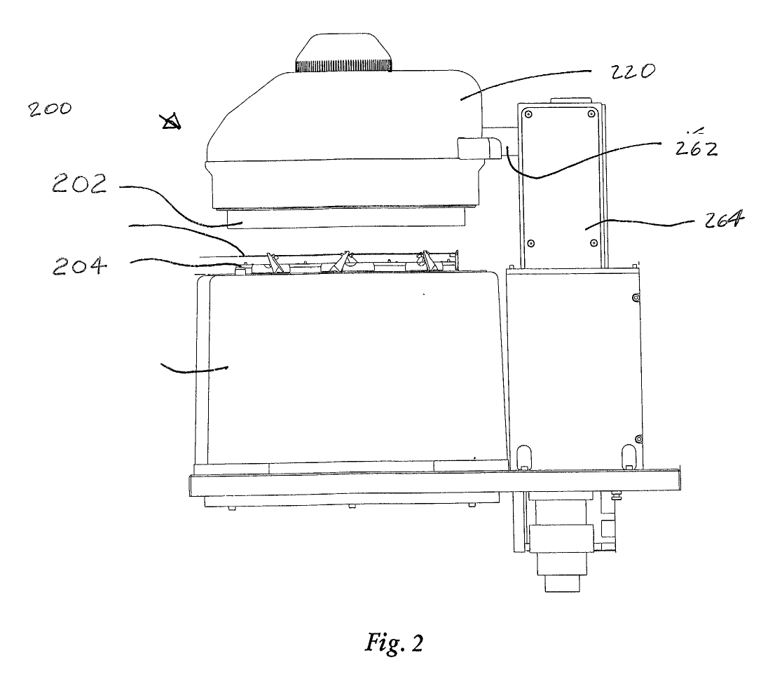

With reference generally to FIGS. 2-6, the rinser/dryer 200 has an upper chamber member or rotor 202 that includes an upper chamber wall 212. A lower chamber member or rotor 204 similarly includes a lower chamber wall 214. These walls 212, 214 open or separate to permit a workpiece 50 to be loaded into the rinser/dryer 200 by the second transfer robot 118. The walls 212, 214, move towards and engage each other to define a capsule assembly 216 containing the workpiece 50 in a processing position, between the walls 212, 214.

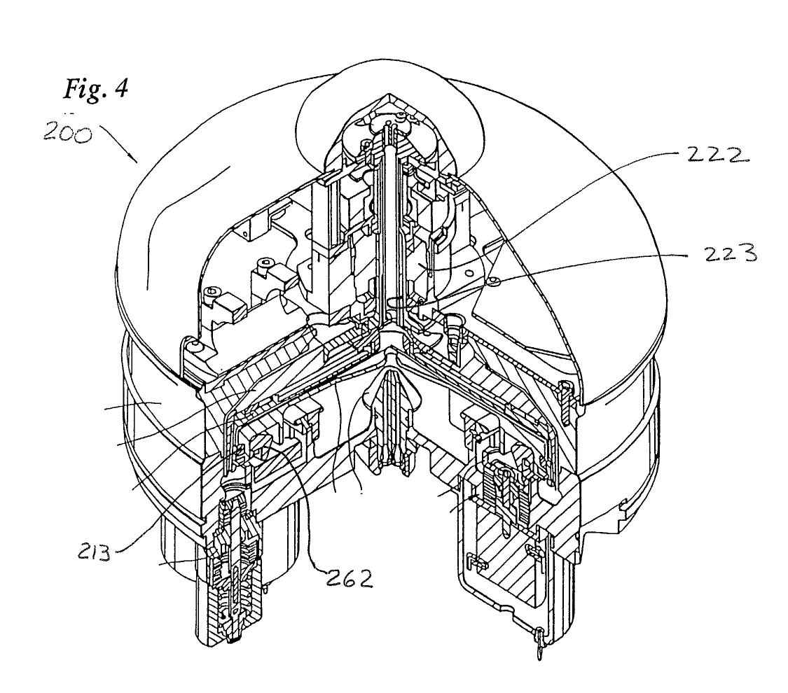

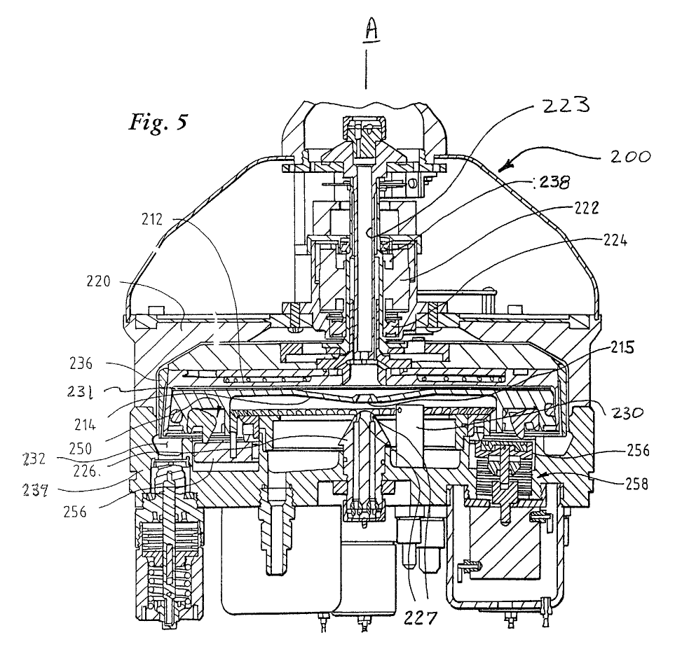

The capsule assembly 216 spins about a rotation axis A. A motor 222 in a head 220 rotates the upper rotor 202 around the axis A, along with the workpiece 50 and the lower rotor 204. Specifically, as shown in FIGS. 4 and 5, the motor 222 drives a sleeve 223, which is supported radially in the head 220, by rolling-bearings 238. The head 220 is pivotably supported on an armature 262 which is raised and lowered by an elevator 264. The head 220 can be raised to separate the walls 212, 214, of the rotors 202, 204 and can be lowered for bringing the walls 212, 214 towards each other.

The upper chamber wall 212 has an inlet 237 for rinsing and drying fluids, which may be liquid, vaporous, or gaseous. The lower chamber wall 214 has an inlet 215 for such fluids, which for a given application may be similar fluids or different fluids. An upper nozzle 229 extends axially through the sleeve 223 So as not to interfere with the rotation of the sleeve 223. The upper nozzle 229 directs streams of rinsing/drying fluids downwardly through the inlet 237 passing through the upper chamber wall 212.

The upper chamber wall 212 includes an array of similar outlets 245, which are spaced similarly at uniform angular spacings around the vertical axis A. Preferably 36 outlets 245 are used. The outlets 245 are spaced outwardly from the vertical axis A by just slightly less than the workpiece radius. The outlets 245 are also spaced inwardly from the outer perimeter of the workpiece 50 supported in the capsule assembly 216 by a much smaller radial distance, such as a distance of approximately 1-5 mm.

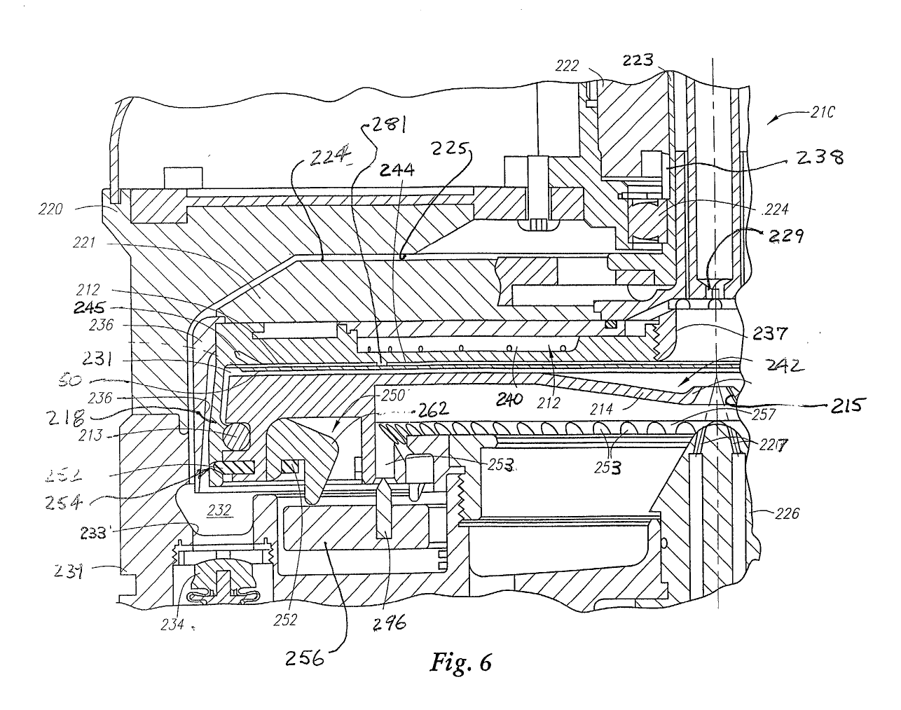

When the upper and lower rotors 202, 204 are brought together as shown in FIG. 6, an upper processing chamber or space 244 formed or is defined by the upper chamber wall 212 and by a first or top generally planar surface of the workpiece 50. Similarly, a lower processing chamber or space 240 is defined or formed by the lower chamber wall 214 and a second generally planar surface of the workpiece 50 opposite the first side. The upper and lower processing chambers 244, 240, are in fluid communication or connected with each other via an annular region 231 beyond the outer perimeter or cage of the workpiece and are sealed by an annular, compressible seal such as an O-ring 213, surrounding the lower portion of the annular region 231. The seal 213 prevents fluid leakage between the rotors 202 and 204, forcing fluid to flow toward the outlets 245.

As illustrated in FIGS. 5-6, the lower chamber wall 214 may have an annular sump 242 around the inlet 215. The sump 242 is used to collect liquids and/or residual fluids supplied through the inlet 215. If a liquid, for example, strikes and drops from a workpiece 50, it is conducted toward the outlet 245 by centrifugal force as the capsule assembly 216 is rotated.

The lower nozzle 226, which is provided beneath the inlet 215 of the lower chamber wall 214, includes two or more ports 227, as shown in FIG. 6, for directing two or more streams of fluid upwardly through the inlet 215. The ports 227 are oriented to cause the directed streams to converge approximately where the directed streams reach the lower surface of the workpiece 50. The rinser/dryer 200 also includes a purging nozzle 230 as shown in FIG. 5, at a side of the lower nozzle 226, for directing a stream of purging gas, such as nitrogen, across the lower nozzle 226.

Referring to FIG. 6, the rinser/dryer 200 may have the lower nozzle 226 and the purging nozzle 228 in a base 239 having a coaxial, annular plenum 232. The plenum 232 has (e.g. four) drains 233 each of which is equipped with a valve, such as a pneumatically actuated poppet valve 234 for opening and closing the drain 233. The drains 233 preferably provide separate paths for conducting liquid of different types to appropriate systems for storage, disposal, or recirculation.

An annular shield or skit 236 may be provided and extending around and downwardly from the upper chamber wall 212, above the plenum 232. The skirt 236 rotates with the upper chamber wall 214 and upper rotor 202. Each outlet 245 is oriented to direct fluids exiting the capsule assembly 216 against the inner surface of the annular skirt 236. The inner surface is flared outwardly and downwardly to cause fluids to flow outwardly and downwardly toward the plenum 232 by centrifugal force. Thus, fluids tend to be swept through the plenum 232, toward the drains 233.

As shown in FIG. 6, the upper rotor 202 has a ribbed surface 224 facing and closely spaced from a smooth lower surface 225 of the head 220, in an annular region connecting with the plenum 232. When the upper rotor 202 rotates, the ribbed surface 224 tends to cause air in the annular region to swirl, so as to help to sweep fluids through the plenum 232, toward the drains 233.

Referring still to FIG. 6, the upper chamber wall 212 has spacers 281 that project downwardly to prevent lifting of the workpiece 50 from the processing position and from touching the upper chamber wall 212. Similarly, posts 295 project upwardly from the lower wall 214 upwardly beyond the outer perimeter of the workpiece to prevent it from shifting off center from the vertical axis A.

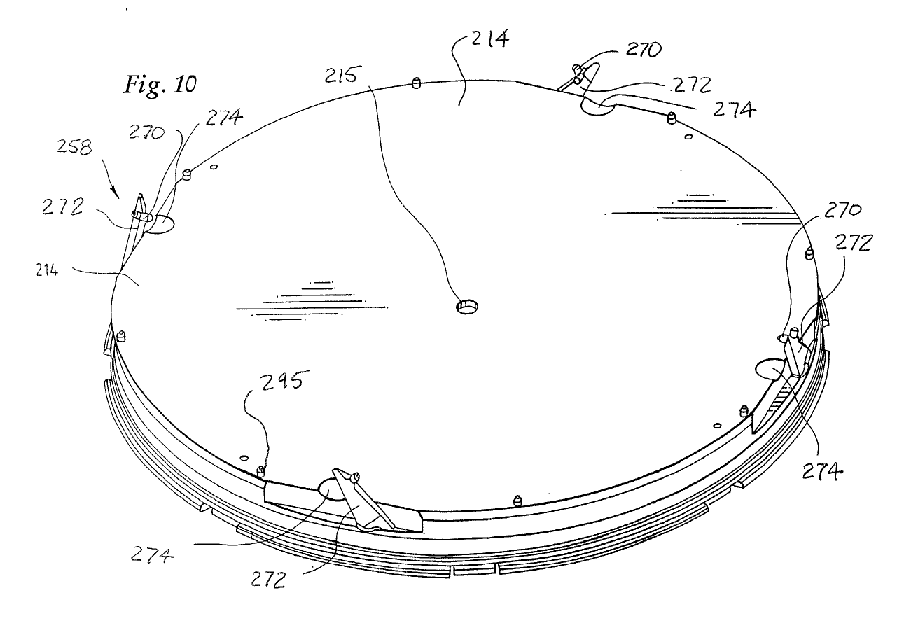

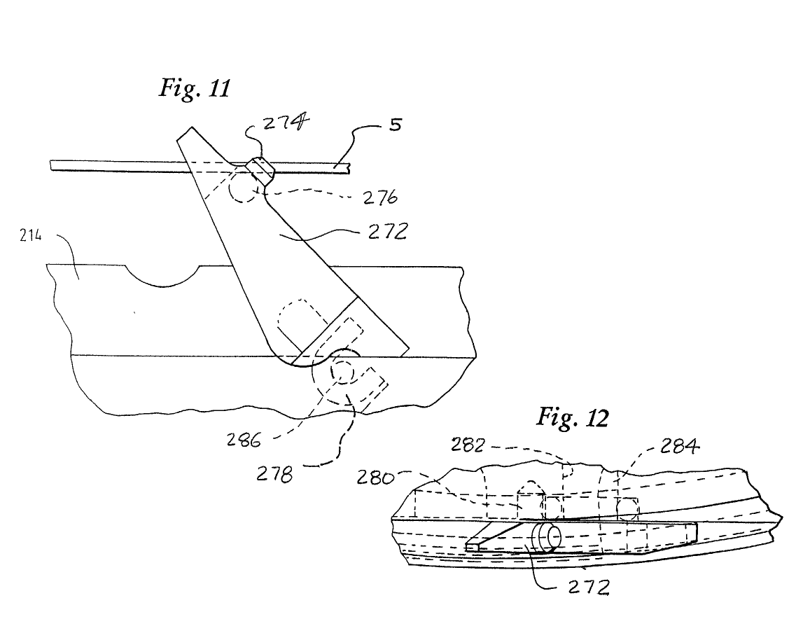

Referring to FIGS. 10-12, the lower rotor 204 preferably includes a lifting mechanism 258 for lifting a workpiece 50 supported in the processing position to an elevated position. The lifting mechanism 258 lifts the workpiece 50 to the elevated position when the head 220 is raised above the base 239, to open the capsule assembly 216. The upper and lower chamber walls 212, 214 move away from each other as the capsule 216 opens. Lifting a workpiece 50 to the elevated position allows the second transfer robot to engage and the workpiece 50.

The lifting mechanism 258 includes lifting levers 272. Each lifting lever 272 is pivotably mounted to the lower chamber wall 214 via a pivot pin 286 extending from the lifting lever 272 into a socket 282 in the lower chamber wall 214. The levers 272 are pivotable between an operative (up) position and an inoperative (down) position. Each pivoting lever 272 is engaged by the upper chamber wall 212 when the upper and lower chamber walls 212, 214, are brought together, whereby the pivoting lever 272 is pivoted into the inoperative or down position. Each lifting lever 272 is biased to pivot into the operative or up position, when not engaged by the upper chamber wall 212.

Thus, each lifting lever 272 is adapted to pivot from the up position into the down position as the upper and lower chamber walls 212, 214, are closed, and to pivot from the down position into the up position as the upper and lower chamber walls 212, 214, are opened. An arm 270 on each lifting lever 272 extends beneath the workpiece 50 supported in the processing position and lifts the workpiece 50 to the elevated position, when the lifting lever 272 is pivoted from the down position into the up position.

The lifting levers 272 may be biased by an elastic member 278 (e.g. an O-ring) surrounding the lower chamber wall 214 and engaging the lifting levers 272, via a hook depending from each lifting lever 272.

The elastic member 278 is maintained under comparatively higher tension when the upper and lower chamber walls 212, 214, are closed, and under comparatively lower tension when the upper and lower chamber walls 212, 214, are opened or spaced further apart.

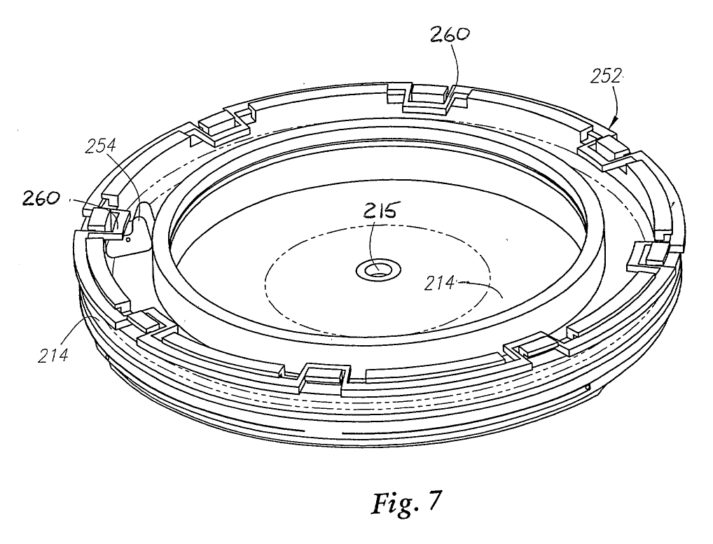

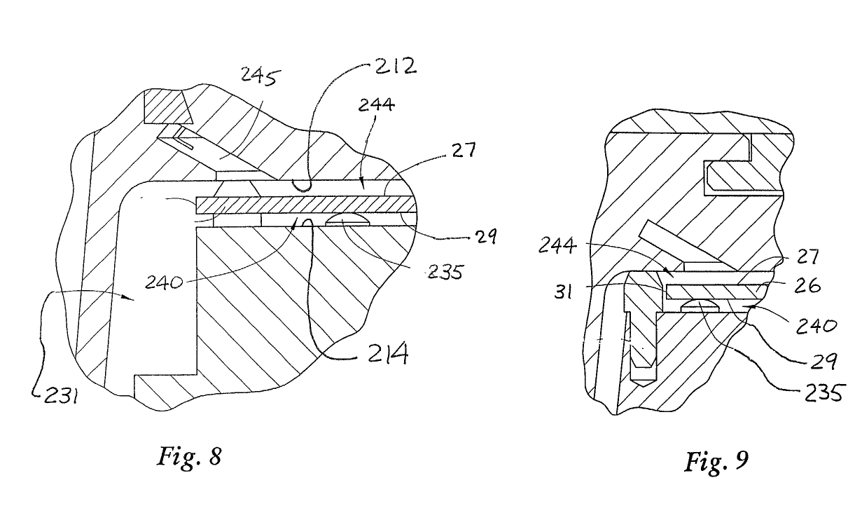

Referring momentarily to FIGS. 5, 6 and 7, the upper and lower chamber walls 212, 214, may also be releasably clamped to each other when in the closed state by a latching mechanism 250. As shown in FIGS. 6 and 7, the latching mechanism includes a latching ring 252 that is carried on the rotor 204 and is adapted to engage a complementary shaped recess 254 the upper chamber wall 212. The latching ring 252 is made from a resilient spring material (e.g. polyvinylidine fluoride) with an array of inwardly stepped sections 260. This section 260 allows the latching ring 252 to deform from an undeformed condition in which the latching ring 252 has a first diameter, into a deformed condition in which the latching ring 252 has a comparatively smaller diameter. This deformation occurs when the stepped portions 260 are subject to radial inward directed forces. Upon removal of the forces, the latching ring 252 returns to the undeformed.

The latching mechanism 250 further includes an array of latching cams 262, each associated with a stepped section 260. The latching cams 254 apply radial forces to the stepped portions 260.

As shown in FIGS. 5 and 6, the latching mechanism 250 further includes an actuating ring 256, which is adapted to actuating the latching cams 262 as the actuating ring 256 is raised and lowered within a predetermined limited range of movement. The actuating ring 256 is raised up to actuate the latching cams 262, and lowered to deactuate the latching cams. Pneumatic lifters 258 are adapted to raise and lower the actuating ring 256. When the actuating ring 256 is raised, the upper and lower chamber walls 212, 214, are released from each other so that the head 220 can be raised from the base 230 for opening the upper and lower chamber walls 212, 214, or lowered onto the base for closing the upper and lower chamber walls 212, 214.

As shown in FIG. 6, pins 296 on the actuating ring 256 project upwardly and into apertures 253 in an aligning ring 257, when the actuating ring 256 is raised. The aligning ring 257 is joined to, and rotates with, the lower rotor 204. The pins 296 are withdrawn from the apertures 253 and clear the aligning ring 257 when the actuating ring 256 is lowered. When projecting into the respective apertures 253, the pins 296 align the workpiece 55, to facilitate unloading the workpiece via the second transfer robot 50.

In use, a wafer or workpiece 50 is transferred from the inside brush station 112 to the rinser/dryer 200 via the first transfer robot 108. The rinser/dryer 200 is in the open position as shown in FIGS. 1 and 2. The upper and lower rotors 202 and 204 are spaced apart from each other. The lifting mechanism 258 is in the up position. The robot 108 moves the wafer 50 into the rinser/dryer 200 and sets it down on the lifting levers 272. The elevator 264 moves the head 220 down. The upper rotor 202 engages the lower rotor 204. The downward movement of the upper rotor 202 pushes the arms 270 down so that the wafer 50 comes to rest on the pins 295.

The circumferential edges of the wafer 50 are centered by the arm posts 274 which are located on a circle concentric with, and slightly larger than, the circle or which the pins 295 are located on. The spacers 281 on the upper rotor 202 come to rest on the top surface of the wafer 50. This securely clamps the wafer 50 in place within the now closed capsule assembly 216. The lifters 258 are lowered or released. The ring 256 moves down. The cams pivot inwardly (toward the axis A-A). The stepped sections 260 of the ring 252 flex outwardly into the recesses 254. This locks the upper and lower rotors together. The flange 218 on the upper rotor 202 moves over the seal 213. This seal stops fluid outflow from the chambers 240 and 244, except via the outlet(s) 245.

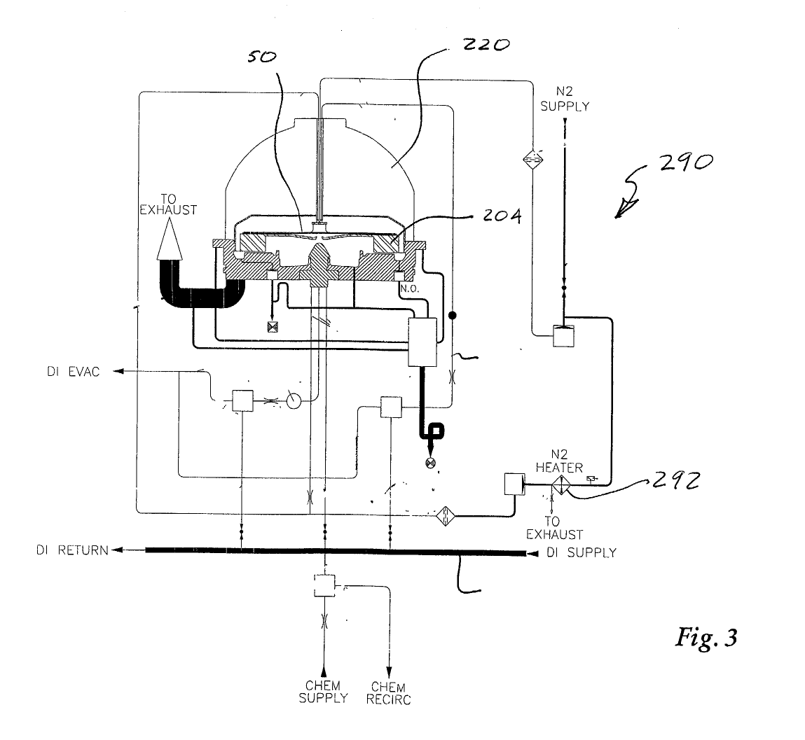

The motor 222 is turned on to spin the capsule assembly 216 (including the upper and lower rotors 202 and 204, and the wafer 50 held between them). A rinsing liquid, such as DI water, is introduced onto the upper and lower wafer surfaces via the inlets 237 and 215. The liquid spreads and flows radially outwardly over the wafer surfaces via centrifugal force and drains out the capsule assembly 216 via the outlets 2345. The rinsing liquid covers or flows over all areas of the workpiece, rinsing away process chemicals remaining on the workpiece from prior processes. The capsule 216 is then typically accelerated to a higher spin speed to remove remaining droplets of rinsing liquid, via centrifugal force. A drying gas may then be applied a gas supply, such as nitrogen supply 290 in FIG. 3. The drying gas, such as air or nitrogen, may be heated via a gas heater 292. When the workpiece is dry, the elevator 264 lifts the head 220 to open the capsule 216. As this occurs, the lifting mechanism 258 lifts the workpiece. The second transfer robot 118 removes the clean and dry workpiece 50 from the rinser/dryer 200, and moves it into a clean cassette 120.

Thus, novel systems and methods have been described. Various changes, substitutions, and use of equivalent components and steps can of course be made without departing from the spirit and scope of the invention. The invention, therefore, should not be limited, except by the following claims and their equivalents.

1. A system for cleaning a workpiece, comprising:
a brush station having brushes for contacting the workpiece and liquid supply for supplying liquid to the workpiece;
a rinser/dryer including a capsule assembly formed by an upper rotor and a lower rotor, with the capsule assembly adapted to hold and spin the workpiece, and the capsule assembly including at least one inlet and at least one outlet; and
a robot moveable to transfer a workpiece from the brush station to the rinser/dryer.

2. The system of claim 1 further including a first inlet in the first rotor for providing a first fluid to an upper surface of the workpiece and a second inlet in the second rotor for providing a second fluid to a lower surface of the workpiece.

3. The system of claim 1 with the at least one outlet positioned to allow escape of fluid from the capsule assembly, by centrifugal force generated by rotating the capsule assembly.

4. The system of claim 1 further including a fluid supply system connected to capsule assembly to sequentially supply at least a rinsing fluid followed by a drying fluid to the capsule assembly.

5. The system of claim 1 where the capsule assembly spins about a vertical axis.

6. The system of claim 1 with the first rotor contained within a head attachable to an elevator, with the head moveable vertically towards and away from the second rotor.

7. The system of claim 1 further including a second brush station including brushes and a liquid supply system.

8. A system for cleaning a workpiece, comprising:
at least one brush station having brushes for brushing a workpiece;
a rinser/dryer including:
a first chamber member having an interior first chamber member wall;
a second chamber member having an interior second chamber member wall, the first and second chamber members adapted for relative movement between a loading position in which the first and second chamber members are spaced apart from each other, and a processing position in which the first and second chamber members are engaged to each other, to define a processing chamber;
at least one workpiece support assembly for supporting the workpiece, the at least one workpiece support assembly having a plurality of support members operable to space the workpiece a first distance from the interior first chamber member wall, when the first and second chamber members are in the loading position, and also operable to space the workpiece a second distance from the interior first chamber member wall, when the first and second chamber members are in the processing position, with the first distance greater than the second distance; and
a robot having an end effector for holding a workpiece, with the robot moveable between the at least one brush station and the rinser/dryer, to transfer a workpiece from the brush station to the rinser/dryer.

9. The system of claim 8 wherein the workpiece support assembly in the rinser/dryer comprises:
a biasing member disposed to engage the workpiece support members, the biasing member urging the workpiece support members to space the workpiece at the first distance from the interior first chamber wall when the first and second chamber members are in the loading position, and with relative movement between the first and second chamber members urging the workpiece support members against the bias of the biasing member to drive the workpiece support members to space the workpiece at the second distance from the first interior chamber wall when the first and second chamber members are in the processing position.

10. The system of claim 8 wherein first and second chamber members move linearly together and apart.

11. The system of claim 8 further including at least one fluid inlet disposed through at least one of the first and second interior chamber walls for delivering fluid onto the workpiece when the first and second chamber members are in the processing position.

12. The system of claim 8 where the upper and lower chamber members form a processing chamber generally conforming to the shape of the workpiece.

13. The system of claim 8 further including a plurality of pins on the bottom wall, adapted to hold a workpiece spaced apart from the bottom wall.

14. The system of claim 13 further including a plurality of top spacing members on the top wall, substantially aligned with the pins.

15. The system of claim 13 where spacing members are adjacent to the outlet.

16. The system of claim 8 further including an annular sidewall on the first chamber member extending towards the second chamber member, and with the annular sidewall positioned so that when a workpiece is placed in the chamber, the circumferential edge of the workpiece is spaced apart from the annular sidewall by a distance substantially equal to the thickness of the workpiece.

17. A system for post CMP cleaning of a semiconductor wafer, comprising:
an outside brush station;
an inside brush station;
a rinser/dryer including a first chamber member having an interior first chamber member wall, a second chamber member having an interior second chamber member wall, the first and second chamber members adapted for relative movement between a loading position in which the first and second chamber members are spaced apart from each other, and a processing position in which the first and second chamber members are engaged to each other, to define a processing chamber;
a first robot moveable between the inside and outside brush stations and the rinser/dryer; and
a second robot moveable between the rinser/dryer and an unload station.
